(19) United States
(12) Patent Application Publication
(10) Pub. No.: US 2026/0094450 A1
(43) Pub. Date: Apr. 2, 2026

(54) MACHINE-LEARNING MODEL FOR VEHICLE OPERATION

(71) Applicant: Ford Global Technologies, LLC, Dearborn, MI (US)

(72) Inventors: Michael Schoenberg, Seattle, WA (US); Shivam Gautam, Austin, TX (US)

(73) Assignee: Ford Global Technologies, LLC, Dearborn, MI (US)

(21) Appl. No.: 18/898,787

(22) Filed: Sep. 27, 2024

(51) Int. Cl. G06V 20/58; G06V 10/77; G06V 10/82

(52) U.S. Cl. CPC G06V 20/58; G06V 10/7715; G06V 10/82

(57) ABSTRACT

A computer includes a processor and a memory, and the memory stores instructions executable by the processor to, in response to a driving context for a vehicle being a first driving context, execute a machine-learning model on board the vehicle with a first portion of the machine-learning model enabled and a second portion of the machine-learning model disabled; and, in response to the driving context being a second driving context, execute the machine-learning model with the first portion disabled and the second portion enabled.

### BACKGROUND

Modern vehicles typically include control modules. The control modules are distinct computing devices. The control modules can be programmed to perform different functions for the vehicle. Typical control modules on board a vehicle include an engine control module, a body control module, an accessory control module, a power-steering control module, an antilock brake control module, etc. A vehicle may contain between fifty and one hundred control modules.

### BRIEF DESCRIPTION OF THE DRAWINGS

FIG. 1 is a block diagram of an example vehicle.

FIG. 2 is a diagram of an example machine-learning model executing on board the vehicle.

FIG. 3 is a flowchart of an example process for executing the machine-learning model based on a driving context of the vehicle.

### DETAILED DESCRIPTION

This disclosure describes a machine-learning model for use on board a vehicle. The machine-learning model includes at least a first portion and a second portion (e.g., as different heads within a deep neural network). A computer on board the vehicle is programmed to execute the machine-learning model with a portion of the machine-learning model selectively enabled based on a driving context for the vehicle. The driving context is a datum or set of data that affects the driving of the vehicle. For example, the driving context may be an operational mode of the vehicle (e.g., whether an adaptive cruise control is engaged or not) or an environmental condition experienced by the vehicle (e.g., daytime versus nighttime, rainy versus clear weather). The computer is programmed to, in response to the driving context being a first driving context, enable the first portion and disable the second portion; and, in response to the driving context being a second driving context, enable the second portion and disable the first portion. The computer thus stores a single machine-learning model that can be used in a specialized manner in multiple driving contexts, rather than multiple machine-learning models for multiple driving contexts. This preserves memory and increases processing speed on board the vehicle, which may have a limited total capacity. The computing hardware for the vehicle can be chosen accordingly (e.g., a single control module instead of two control modules). Moreover, if the driving context is dependent on a trim package or customer selection for the vehicle, the same selection of computing hardware can be used across different vehicles instead of different types of computing hardware in different vehicles, simplifying the manufacturing process.

A computer includes a processor and a memory, and the memory stores instructions executable by the processor to, in response to a driving context for a vehicle being a first driving context, execute a machine-learning model on board the vehicle with a first portion of the machine-learning model enabled and a second portion of the machine-learning model disabled; and, in response to the driving context being a second driving context, execute the machine-learning model with the first portion disabled and the second portion enabled.

In an example, the instructions may further include instructions to actuate a component of the vehicle based on an output of the machine-learning model. In a further example, the output of the machine-learning model may include detections of objects in an environment surrounding the vehicle.

In an example, the first portion may include at least one first head, and the second portion may include at least one second head. In a further example, the machine-learning model may include a common portion, and the at least one first head and the at least one second head may be arranged in the machine-learning model to receive input from the common portion. In a yet further example, the common portion may be trained to perform feature extraction on sensor data. In a still yet further example, the at least one first head and the at least one second head may be trained to perform object detection based on features from the feature extraction.

In an example, the first portion may be trained to perform object detection, and the second portion may be trained to perform object detection.

In an example, the machine-learning model may be a deep neural network.

In an example, the driving context may be an operational mode of the vehicle. In a further example, the operational mode may indicate whether a component of the vehicle is controlled by the computer or by an operator of the vehicle.

In an example, the driving context may be an environmental condition experienced by the vehicle. In a further example, the first driving context may be daytime, and the second driving context may be nighttime.

In an example, the driving context may be a weather condition.

In an example, the driving context may be a location of the vehicle.

A method includes, in response to a driving context for a vehicle being a first driving context, executing a machine-learning model on board the vehicle with a first portion of the machine-learning model enabled and a second portion of the machine-learning model disabled; and, in response to the driving context being a second driving context, executing the machine-learning model with the first portion disabled and the second portion enabled.

In an example, the method may further include actuating a component of the vehicle based on an output of the machine-learning model.

In an example, the first portion may include at least one first head, the second portion may include at least one second head, the machine-learning model may includes a common portion, and the at least one first head and the at least one second head may be arranged in the machine-learning model to receive input from the common portion. In a further example, the common portion may be trained to perform feature extraction on sensor data, and the at least one first head and the at least one second head may be trained to perform object detection based on features from the feature extraction.

In an example, the driving context may be one of an operational mode of the vehicle or an environmental condition experienced by the vehicle.

With reference to the Figures, wherein like numerals indicate like parts throughout the several views, a computer 105 includes a processor and a memory, and the memory stores instructions executable by the processor to, in response to a driving context for a vehicle 100 being a first driving context, execute a machine-learning model 200 on board the vehicle 100 with a first portion 205 of the machine-learning model 200 enabled and a second portion 210 of the machine-learning model 200 disabled; and, in response to the driving context being a second driving context, execute the machine-learning model 200 with the first portion 205 disabled and the second portion 210 enabled.

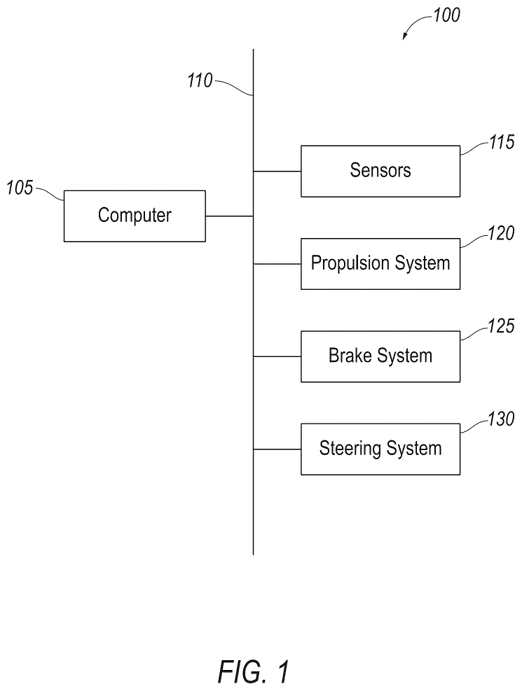

With reference to FIG. 1, the vehicle 100 may be any passenger or commercial automobile such as a car, a truck, a sport utility vehicle, a crossover, a van, a minivan, a taxi, a bus, etc. The vehicle 100 includes the computer 105, a communications network 110, sensors 115, a propulsion system 120, a brake system 125, and a steering system 130.

The computer 105 is a microprocessor-based computing device such as a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design to describe digital and mixed-signal systems such as FPGA and ASIC. For example, an ASIC is manufactured based on VHDL programming provided pre-manufacturing, whereas logical components inside an FPGA may be configured based on VHDL programming (e.g., stored in a memory electrically connected to the FPGA circuit). The computer 105 can thus include a processor, a memory, etc. The memory of the computer 105 can include media for storing instructions executable by the processor as well as for electronically storing data and/or databases, and/or the computer 105 can include structures such as the foregoing by which programming is provided. The computer 105 can be multiple computers coupled together.

The computer 105 may transmit and receive data through the communications network 110. The communications network 110 may be a controller area network (CAN) bus, Ethernet, WiFi, Local Interconnect Network (LIN), onboard diagnostics connector (OBD-II), and/or any other wired or wireless communications network. The computer 105 may be communicatively coupled to the sensors 115, the propulsion system 120, the brake system 125, the steering system 130, and other components via the communications network 110.

The sensors 115 may provide data about operation of the vehicle 100, for example, wheel speed, wheel orientation, and engine and transmission data (e.g., temperature, fuel consumption, etc.). The sensors 115 may detect the location and/or orientation of the vehicle 100. For example, the sensors 115 may include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors 115 may detect the external world, including objects and/or characteristics of surroundings of the vehicle 100, such as other vehicles, road lane markings, traffic lights and/or signs, road users, etc. For example, the sensors 115 may include radar sensors, ultrasonic sensors, scanning laser range finders, light detection and ranging (lidar) devices, and image processing sensors such as cameras.

The computer 105 may be programmed to receive sensor data 225 from the sensors 115. For example, the computer 105 may receive image data from one or more cameras, range data from one or more radars or lidars, etc.

The image data are a sequence of image frames of the fields of view of the respective sensors 115 that are cameras. Each image frame is a two-dimensional matrix of pixels. Each pixel has a brightness or color represented as one or more numerical values, such as a scalar unitless value of photometric light intensity between 0 (black) and 1 (white), or values for each of red, green, and blue (e.g., each on an 8-bit scale (0 to 255) or a 12- or 16-bit scale). The pixels may be a mix of representations (e.g., a repeating pattern of scalar values of intensity for three pixels and a fourth pixel with three numerical color values, or some other pattern). Position in an image frame (i.e., position in the field of view of the sensor at the time that the image frame was recorded) can be specified in pixel dimensions or coordinates (e.g., an ordered pair of pixel distances), such as a number of pixels from a top edge and a number of pixels from a left edge of the image frame.

The range data may be, for example, a point cloud. The points of the point cloud specify respective positions in the environment relative to the position of the ranging sensor (e.g., radar or lidar) of the sensors 115. For example, the range data can be in spherical coordinates with the ranging sensor at the origin of the spherical coordinate system. The spherical coordinates can include a radial distance (i.e., a measured depth from the ranging sensor to the point measured by the ranging sensor); a polar angle (i.e., an angle from a vertical axis through the ranging sensor to the point measured by the ranging sensor); and an azimuthal angle (i.e., an angle in a horizontal plane from a horizontal axis through the ranging sensor to the point measured by the ranging sensor). The horizontal axis can be, for example, along a vehicle-forward direction. Alternatively, the ranging sensor can return the points as Cartesian coordinates with the ranging sensor at the origin or as coordinates in any other suitable coordinate system, or the computer 105 can convert the spherical coordinates to Cartesian coordinates or another coordinate system after receiving the range data.

The propulsion system 120 of the vehicle 100 generates energy and translates the energy into motion of the vehicle 100. The propulsion system 120 may be a conventional vehicle propulsion subsystem, for example, a conventional powertrain including an internal-combustion engine coupled to a transmission that transfers rotational motion to wheels; an electric powertrain including batteries, an electric motor, and a transmission that transfers rotational motion to the wheels; a hybrid powertrain including elements of the conventional powertrain and the electric powertrain; or any other type of propulsion. The propulsion system 120 can include an electronic control unit (ECU) or the like that is in communication with and receives input from the computer 105 and/or a human operator. The human operator may control the propulsion system 120 via, for example, a pedal and/or a gear-shift lever.

The brake system 125 is typically a conventional vehicle braking subsystem and resists the motion of the vehicle 100 to thereby slow and/or stop the vehicle 100. The brake system 125 may include friction brakes such as disc brakes, drum brakes, band brakes, etc.; regenerative brakes; any other suitable type of brakes; or a combination. The brake system 125 can include an electronic control unit (ECU) or the like that is in communication with and receives input from the computer 105 and/or a human operator. The human operator may control the brake system 125 via, for example, a brake pedal.

The steering system 130 is typically a conventional vehicle steering subsystem and controls the turning of the wheels. The steering system 130 may be a rack-and-pinion system with electric power-assisted steering, a steer-by-wire system, as both are known, or any other suitable system. The steering system 130 can include an electronic control unit (ECU) or the like that is in communication with and receives input from the computer 105 and/or a human operator. The human operator may control the steering system 130 via, for example, a steering wheel.

As the vehicle 100 operates, the vehicle 100 is in a driving context. For the purposes of this disclosure, a “driving context” is defined as a datum or set of data that affects the driving of the vehicle 100. For example, the driving context may be an operational mode of the vehicle 100 (e.g., whether an adaptive cruise control is engaged or not), an environmental condition experienced by the vehicle 100 (e.g., daytime versus nighttime, rainy versus clear weather), or a location of the vehicle 100 (e.g., a limited-access highway versus a surface street), as will be described in turn below. The computer 105 may be programmed to determine the driving context, as will be described with respect to the types of driving contexts below.

The driving context may be an operational mode of the vehicle 100. For the purposes of this disclosure, an “operational mode” is defined as a datum or set of data indicating how one or more components of the vehicle 100 operate (e.g., the propulsion system 120, the brake system 125, and/or the steering system 130). For example, the operational mode may indicate how the components are controlled, such as whether the components are controlled by the computer 105 or by an operator of the vehicle 100. As one example, the operational mode may indicate whether an adaptive cruise control is engaged, which indicates whether the propulsion system 120 is being controlled by the computer 105 (when engaged) or by the operator (when not engaged). Adaptive cruise control is an example of an advanced driver assistance system (ADAS). ADAS are electronic technologies that assist drivers in driving and parking functions. Examples of ADAS include forward proximity detection, lane-departure detection, blind-spot detection, braking actuation, adaptive cruise control, and lane-keeping assistance systems. The operational mode may indicate whether one or combinations of ADAS features or more advanced autonomous features are engaged. The operational mode may be selected from a plurality of prestored operational modes (e.g., a first operational mode, a second operational mode, etc.). The computer 105 may determine the operational mode by consulting a flag in the memory of the computer 105. The computer 105 sets the flag when putting the vehicle 100 into a specific operational mode.

Alternatively or additionally, the driving context may be an environmental condition experienced by the vehicle 100. For example, the driving context may be an ambient light level, a weather condition, etc. The ambient light level may be daytime, nighttime, etc. The computer 105 may determine the ambient light level based on data from the sensors 115. The sensors 115 may include an ambient-light sensor, which is a photodetector that detects an amount of ambient light present (i.e., a total light level from sources in the environment). The ambient-light sensor may be any suitable type, such as phototransistor, photodiode, photonic integrated circuit, etc. The computer may determine that the driving context is daytime in response to the ambient light level exceeding a threshold and that the driving context is nighttime in response to the ambient light level being below the threshold.

The weather condition may be defined by an ambient temperature (e.g., above or below the freezing point), a precipitation classification (e.g., rainy, snowy, clear), a wind speed, a visibility amount (e.g., foggy or clear), etc. The computer 105 may determine the weather condition by receiving a weather forecast from an external source or may determine the weather condition based on data from the sensors 115. The sensors 115 may include an outside ambient temperature sensor (OATS) that measures ambient temperature. The computer 105 may apply object recognition to image data from a camera of the sensors 115 to detect, for example, the precipitation classification.

Alternatively or additionally, the driving context may be a location of the vehicle 100. For example, the location may be on a particular type of road, a particular geographic area, etc. The type of road may be an expressway (i.e., a limited-access highway such as a freeway or tollway), an undivided highway, a city street, a parking lot, etc. The geographic area may be a city, a state or province, a country, etc. The computer 105 may store a plurality of preset location types and may determine the driving context by selecting from the preset location types. The computer 105 may select the preset location type by comparing a position of the vehicle 100 returned by the sensors 115 (e.g., by a GNSS sensor) with map data defining the preset location types (e.g., defining the boundaries of roads or geographic areas of different types).

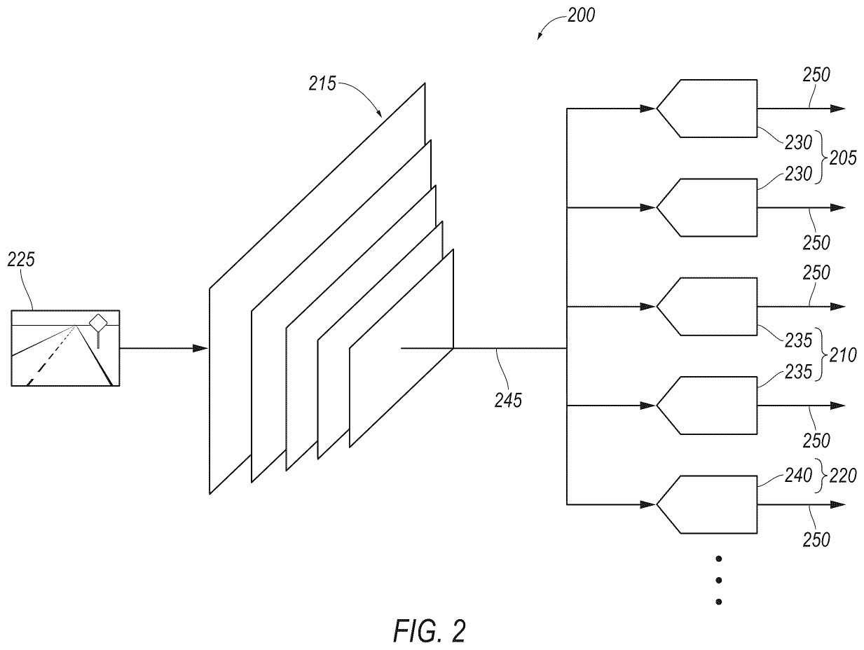

With reference to FIG. 2, the computer 105 stores the machine-learning model 200 in memory. The machine-learning model 200 may include a common portion 215, the first portion 205, the second portion 210, and possibly other portions, which will be referred to as a third portion 220. The computer 105 is programmed to execute the machine-learning model 200. As a general overview, the common portion 215 may receive sensor data 225 as an input and generate an output (e.g., a feature map 245). The computer 105 enables one of the first portion 205 or second portion 210 (or possibly third portion 220), and correspondingly disables the other of the first portion 205 or second portion 210, based on the driving context as determined above. The computer 105 enables the first portion 205 and disables the second portion 210 (and possibly third portion 220) in response to the driving context being a first driving context, enables the second portion 210 and disables the first portion 205 (and possibly the third portion 220) in response to the driving context being a second driving context, and may enable the third portion 220 and disable the first and second portions 205, 210 in response to the driving context being a third driving context. Whichever portion 205, 210, 220 is enabled receives the output from the common portion 215 as an input and generates an output (e.g., detections 250), which is an output of the machine-learning model 200 as a whole. Whichever portions 205, 210, 220 are disabled do not execute when the computer 105 executes the machine-learning model 200. The computer 105 may actuate a component based on the output of the machine-learning model 200.

The machine-learning model 200 may be a deep neural network. A neural network includes a series of layers, with each layer using one or more other layers as input. Each layer contains a plurality of neurons that receive as input data generated by a subset of the neurons of the other layers and generate output that is sent to other neurons in the other layers. The neural network includes a plurality of weights. Each weight may apply to a connection between two neurons. Thus, for a given neuron, the outputs from the neurons feeding into the given neuron are weighted by the respective weights for the connections from those neurons to the given neuron. The output of each neuron may be a function of the weighted inputs from the input neurons (i.e., nᵢ=f(wⱼᵢ*nⱼ, wₖᵢ*nₖ, . . . ) in which i, j, and k are indexes of the neurons, nᵢ is the output of the ith neuron, and wⱼᵢ is the weight of the connection from the jth neuron to the ith neuron). The output of each neuron may also be a function of biases of the input neurons.

The deep neural network may be any suitable type, such as a convolutional neural network, a recurrent neural network, etc. For example, in a convolutional neural network, each layer uses the immediately previous layer as input. Types of layers include convolutional layers, which compute a dot product of a weight and a small region of input data; pool layers, which perform a downsampling operation along spatial dimensions; and fully connected layers, which generate based on the output of all neurons of the previous layer.

The machine-learning model 200 may include the common portion 215 and a plurality of heads 230, 235, 240. The heads 230, 235, 240 are arranged in the machine-learning model 200 to receive input from the common portion 215, in other words, to receive the output of the common portion 215 as an input. The common portion 215 may be, for example, an encoder. The heads 230, 235, 240 are included in the first portion 205, second portion 210, and possibly third portion 220. The first portion 205 includes at least one first head 230, the second portion 210 includes at least one second head 235, and the third portion 220 may include at least one third head 240. The heads 230, 235, 240 are distinct subroutines of the machine-learning model 200 that are able to be removed without affecting the operation of the rest of the machine-learning model 200.

The output of the common portion 215 includes features. For example, the output of the common portion 215 may include a feature map 245. The feature map 245 includes a plurality of features. For the purposes of this disclosure, the term “feature” is used in its computer-vision sense as a piece of information about the content of an image or point cloud, specifically about whether a certain region of the image or point cloud has certain properties. Types of features may include edges, corners, blobs, etc. For an image, the feature map 245 provides locations in an image frame (e.g., in pixel coordinates) of the features. A feature map 245 has a reduced dimensionality compared to the image frame. For example, the output may be a feature pyramid, which includes a plurality of feature maps 245 of varied dimensionalities. For example, each feature map 245 of a given feature pyramid may be downscaled by a different factor from the image frame, such as downscaled a different number of times by a factor of 2 (e.g., five feature maps 245 downscaled by a factor of 2 ranging from three to seven times). For another example, the output may embed the features in a different way, such as a latent vector or another type of intermediate machine-learning output. The features may or may not be legible to humans.

The common portion 215 may be trained to perform feature extraction on the sensor data 225 in order to detect the features (e.g., generate the feature map 245). For example, the common portion 215 may be trained to generate the feature map 245 from the image data (e.g., from an image frame of the image data). The common portion 215 may be a feature extractor. The feature extractor may include one or more suitable techniques for feature extraction, such as low-level techniques such as edge detection, corner detection, blob detection, ridge detection, scale-invariant feature transform (SIFT), etc.; shape-based techniques such as thresholding, blob extraction, template matching, Hough transform, generalized Hough transform, etc.; flexible methods such as deformable parameterized shapes, active contours, etc.; etc. The common portion 215 includes machine-learning operations. For example, the common portion 215 may include residual network (ResNet) layers followed by a convolutional neural network. For another example, the common portion 215 may be an encoder portion of an encoder-decoder network, and the common portion 215 may be trained as part of training the encoder-decoder network. For another example, the common portion 215 may be trained as part of training the machine-learning model 200, as described below.

The output of the machine-learning model 200 may include detections 250 of objects in an environment surrounding the vehicle 100. The first portion 205, second portion 210, and third portion 220 may be trained to perform object detection. Different heads 230, 235, 240 may be trained to perform object detection of different respective types of object. For example, one or more heads 230, 235, 240 may be trained to detect lane lines of a road on which the vehicle 100 is traveling, one or more heads 230, 235, 240 may be trained to detect road signs, one or more heads 230, 235, 240 may be trained to detect other vehicles, etc. The heads 230, 235, 240 may be trained to perform object detection based on the features from the feature extraction (i.e., on the output of the common portion 215). Different heads 230, 235, 240 may be trained to perform object detection at different respective resolutions (e.g., using different feature maps 245 from a feature pyramid). The heads 230, 235, 240 can detect the objects of the respective types at the respective resolutions by using any machine-learning technique suitable for object detection, such as knowledge-based techniques such as a multiresolution rule-based method; feature-invariant techniques such as grouping of edges, space gray-level dependence matrix, or mixture of Gaussian; template-matching techniques such as shape template or active shape model; or appearance-based techniques such as decomposition and clustering, Gaussian distribution and multilayer perceptron, neural network, support vector machine with polynomial kernel, a naive Bayes classifier with joint statistics of local appearance and position, or higher order statistics with hidden Markov model.

The computer 105 may be programmed to generate respective bounding boxes around the detected objects in the sensor data 225. Each bounding box can be defined by, for an image frame, pixel coordinates of opposite corners of the bounding box, thereby specifying a rectangle, or for a point cloud, spatial coordinates specifying a rectangular prism. For example, the computer 105 may generate the bounding boxes around the regions from the object detection that the respective head 230, 235, 240 identified as a detected object. The computer 105 may generate each bounding box to be a minimum size encompassing the respective region (e.g., by using the highest and lowest vertical pixel coordinates and leftmost and rightmost horizontal pixel coordinates of the region to make the pairs of pixel coordinates for the bounding boxes).

The computer 105 is programmed to enable and disable the first, second, and possibly third portions 205, 210, 220 of the machine-learning model 200. When a portion 205, 210, 220 is enabled, the computer 105 executes that portion 205, 210, 220 as part of executing the machine-learning model 200. When a portion 205, 210, 220 is disabled, the computer 105 executes the machine-learning model 200 without executing that portion 205, 210, 220. The computer 105 may execute the machine-learning model 200 with the first portion 205 enabled and the second portion 210 disabled (and the third portion 220 enabled or disabled). The computer 105 may execute the machine-learning model 200 with the first portion 205 disabled and the second portion 210 enabled (and the third portion 220 enabled or disabled). The computer 105 may execute the machine-learning model 200 with the third portion 220 enabled and the first and second portions 205, 210 enabled or disabled.

The enabling of the first portion 205 and the second portion 210 may be mutually exclusive. In other words, the computer 105 may disable the second portion 210 in response to the first portion 205 being enabled, and the computer 105 may disable the first portion 205 in response to the second portion 210 being enabled.

The computer 105 may enable and disable the first portion 205 and the second portion 210 based on the driving context of the vehicle 100. The computer 105 may enable the first portion 205 and disable the second portion 210 in response to the driving context being a first driving context, and enable the second portion 210 and disable the first portion 205 in response to the driving context being a second driving context. The computer 105 may determine the driving context as described above. The computer 105 may store a table in memory pairing possible driving contexts with identifiers of the first portion 205 or second portion 210 of the machine-learning model 200. The following table is an example of when the driving context is the weather conditions:

| Driving | | |
|---|---|---|
| Context | Enabled Portions | Disabled Portions |
| Rainy | First portion 205 | Second portion 210, |
| | | third portion 220 |
| Snowy | Second portion 210 | First portion 205, |
| | | third portion 220 |
| Clear | Third portion 220 | First portion 205, |
| | | second portion 210 |

In the example of the table, the first driving context is rainy weather conditions, the second driving context is snowy weather conditions, and a third driving context is clear weather conditions. The portions 205, 210, 220 enabled for a specific driving context may be chosen based on, for example, being trained for that specific driving context. In the example of the table, the first portion 205 may include a first head 230 for detecting lane lines trained on rainy weather, the second portion 210 may include a second head 235 for detecting lane lines trained on snowy weather, and the third portion 220 may include a third head 240 for detecting lane lines trained on clear weather. Alternatively or additionally, the portions 205, 210, 220 enabled for a specific driving context may be chosen based on being trained on the resolution available for that specific driving context, which may be different in different operational modes.

The machine-learning model 200 may be trained on separate sets of training data for each portion 205, 210, 220 that can be enabled. For example, the training data may include a first set of training data of images captured during the first driving context, a second set of training data of images captured during the second driving context, etc. During training runs, the machine-learning model 200 may be executed with the first portion 205 enabled and the second portion 210 disabled when receiving the first set of training data, with the second portion 210 enabled and the first portion 205 disabled when receiving the second set of training data, etc. The training data may be annotated with ground-truth detections, and a loss function may be calculated that accumulates errors in detecting the ground-truth detections collected across the sets of training data. The quantities of the sets of training data may be chosen to be balanced with respect to each other. The machine-learning model 200 may be trained with any suitable training method, for example, supervised reinforcement learning with backpropagation from the loss function.

The computer 105 is programmed to execute the machine-learning model 200. As part of executing the machine-learning model 200, the computer 105 accordingly executes the enabled portions 205, 210, 220 and does not execute the disabled portions 205, 210, 220. The machine-learning model 200 may generate outputs from the enabled portions 205, 210, 220 and not the disabled portions 205, 210, 220 (e.g., detections 250 from each head 230, 235, 240 in an enabled portion 205, 210, 220 and not from the heads 230, 235, 240 in the disabled portions 205, 210, 220). For example, the machine-learning model 200 may output detections 250 of objects from each head 230, 235, 240 that is in one of the enabled portions 205, 210, 220.

The computer 105 is programmed to actuate a component of the vehicle 100 based on the output of the machine-learning model 200. In the context of the present disclosure, “actuating” is defined as setting an object into motion via a mechanical or electromechanical stimulus. The component may include the propulsion system 120, the brake system 125, and/or the steering system 130. For example, the computer 105 may actuate the component in executing an ADAS. The computer 105 may actuate the component based on the detections 250 (e.g., the identifications and bounding boxes for the detected objects) returned by the heads 230, 235, 240 in the enabled portions 205, 210, 220 of the machine-learning model 200. For example, the computer 105 may actuate the brake system 125 to stop the vehicle 100 before reaching one of the detected objects. For another example, the computer 105 may actuate the steering system 130 to steer the vehicle 100 within detected lane lines. For another example, the computer 105 may operate the vehicle 100 autonomously, in other words, actuate the propulsion system 120, the brake system 125, and the steering system 130 based on the detected objects. The computer 105 may execute a path-planning algorithm to navigate the vehicle 100 around the detected objects and within detected lane lines.

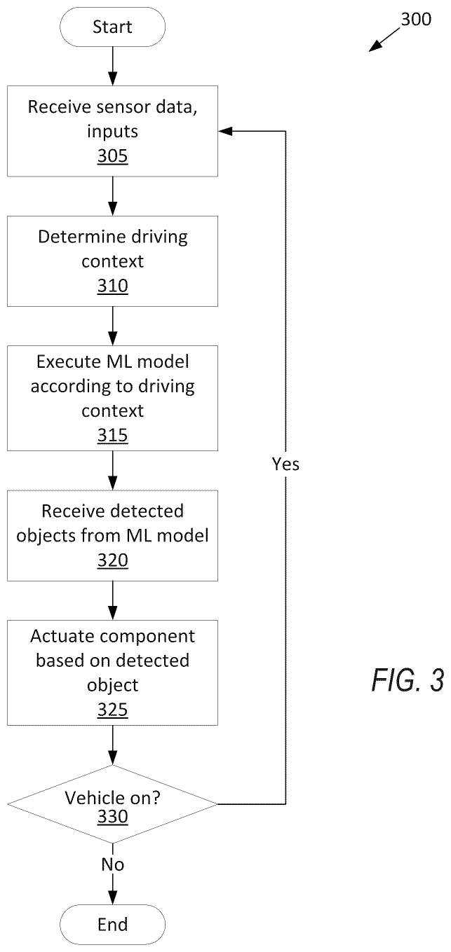

FIG. 3 is a flowchart illustrating an example process 300 for executing the machine-learning model 200 based on the driving context of the vehicle 100. The memory of the computer 105 stores executable instructions for performing the steps of the process 300 and/or programming can be implemented in structures such as mentioned above. As a general overview of the process 300, the computer 105 receives the sensor data 225 and inputs from an operator, determines the driving context of the vehicle 100, executes the machine-learning model 200 according to the driving context, receives the output of the machine-learning model 200, and actuates a component of the vehicle 100 based on the output of the machine-learning model 200. The process 300 continues for as long as the vehicle 100 remains on.

The process 300 begins in a block 305, in which the computer 105 receives the sensor data 225 from the sensors 115 and possibly an input from the operator setting an operational mode of the vehicle 100, as described above.

Next, in a block 310, the computer 105 determines the driving context based on the data from the block 305, as described above.

Next, in a block 315, the computer 105 enables and disables portions 205, 210, 220 of the machine-learning model 200 based on the driving context from the block 310 and executes the machine-learning model 200, as described above. The computer 105, in response to the driving context being a first driving context, executes the machine-learning model 200 with the first portion 205 enabled and the second portion 210 disabled; and, in response to the driving context being a second driving context, executes the machine-learning model 200 with the first portion 205 disabled and the second portion 210 enabled.

Next, in a block 320, the computer 105 receives the output generated by the machine-learning model 200 in the block 315 (e.g., the detections 250 from the enabled heads 230, 235, 240), as described above.

Next, in a block 325, the computer 105 actuates a component of the vehicle 100 based on the output of the machine-learning model 200 from the block 320, as described above.

Next, in a decision block 330, the computer 105 determines whether the vehicle 100 is still on (i.e., is in an on state). For the purposes of this disclosure, “on state” is defined as the state of the vehicle 100 in which full electrical energy is provided to electrical components of the vehicle 100 and the vehicle 100 is ready to be driven (e.g., the engine is running); “off state” is defined as the state of the vehicle 100 in which a low amount of electrical energy is provided to selected electrical components of the vehicle 100, typically used when the vehicle 100 is being stored; and “accessory-power state” is defined as the state of the vehicle 100 in which full electrical energy is provided to more electrical components than in the off state and the vehicle 100 is not ready to be driven. Typically, an operator puts the vehicle 100 into the on state when the operator is going to operate the vehicle 100, puts the vehicle 100 into the off state when the operator is going to leave the vehicle 100, and puts the vehicle 100 into the accessory-power state when the operator is going to sit in but not operate the vehicle 100. In response to the vehicle 100 being in the on state, the process 300 returns to the block 305 to continue actuating the vehicle 100 according to the sensor data 225. In response to the vehicle 100 being in an off state or an accessory-power state, the process 300 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions (e.g., from a memory, a computer readable medium, etc.) and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. Operations, systems, and methods described herein should always be implemented and/or performed in accordance with an applicable owner's/user's manual and/or safety guidelines.

The disclosure has been described in an illustrative manner, and it is to be understood that the terminology which has been used is intended to be in the nature of words of description rather than of limitation. The adjectives “first,” “second,” and “third” are used throughout this document as identifiers and are not intended to signify importance, order, or quantity. Use of “in response to,” “upon determining,” etc. indicates a causal relationship, not merely a temporal relationship. Many modifications and variations of the present disclosure are possible in light of the above teachings, and the disclosure may be practiced otherwise than as specifically described.

What is claimed is:

1. A computer comprising a processor and a memory, the memory storing instructions executable by the processor to:
in response to a driving context for a vehicle being a first driving context, execute a machine-learning model on board the vehicle with a first portion of the machine-learning model enabled and a second portion of the machine-learning model disabled; and
in response to the driving context being a second driving context, execute the machine-learning model with the first portion disabled and the second portion enabled.

2. The computer of claim 1, wherein the instructions further include instructions to actuate a component of the vehicle based on an output of the machine-learning model.

3. The computer of claim 2, wherein the output of the machine-learning model includes detections of objects in an environment surrounding the vehicle.

4. The computer of claim 1, wherein:
the first portion includes at least one first head; and
the second portion includes at least one second head.

5. The computer of claim 4, wherein:
the machine-learning model includes a common portion; and
the at least one first head and the at least one second head are arranged in the machine-learning model to receive input from the common portion.

6. The computer of claim 5, wherein the common portion is trained to perform feature extraction on sensor data.

7. The computer of claim 6, wherein the at least one first head and the at least one second head are trained to perform object detection based on features from the feature extraction.

8. The computer of claim 1, wherein the first portion is trained to perform object detection, and the second portion is trained to perform object detection.

9. The computer of claim 1, wherein the machine-learning model is a deep neural network.

10. The computer of claim 1, wherein the driving context is an operational mode of the vehicle.

11. The computer of claim 10, wherein the operational mode indicates whether a component of the vehicle is controlled by the computer or by an operator of the vehicle.

12. The computer of claim 1, wherein the driving context is an environmental condition experienced by the vehicle.

13. The computer of claim 12, wherein the first driving context is daytime, and the second driving context is nighttime.

14. The computer of claim 1, wherein the driving context is a weather condition.

15. The computer of claim 1, wherein the driving context is a location of the vehicle.

16. A method comprising:
in response to a driving context for a vehicle being a first driving context, executing a machine-learning model on board the vehicle with a first portion of the machine-learning model enabled and a second portion of the machine-learning model disabled; and
in response to the driving context being a second driving context, executing the machine-learning model with the first portion disabled and the second portion enabled.

17. The method of claim 16, further comprising actuating a component of the vehicle based on an output of the machine-learning model.

18. The method of claim 16, wherein:
the first portion includes at least one first head;
the second portion includes at least one second head;
the machine-learning model includes a common portion; and
the at least one first head and the at least one second head are arranged in the machine-learning model to receive input from the common portion.

19. The method of claim 18, wherein:
the common portion is trained to perform feature extraction on sensor data; and
the at least one first head and the at least one second head are trained to perform object detection based on features from the feature extraction.

20. The method of claim 16, wherein the driving context is one of an operational mode of the vehicle or an environmental condition experienced by the vehicle.
